(19) United States
(12) Patent Application Publication
(10) Pub. No.: US 2013/0340902 A1
(43) Pub. Date: Dec. 26, 2013

(54) Shweel

(71) Applicant: Zoltan A. Kemeny, Tempe, AZ (US)

(72) Inventor: Zoltan A. Kemeny, Tempe, AZ (US)

(21) Appl. No.: 13/507,392

(22) Filed: Jun. 25, 2012

(51) Int. Cl. B60B 9/26

(52) U.S. Cl. 152/1

(57) ABSTRACT

Shock-absorbers used as wheel-spokes between wheel-hub and rigid rim, which may be lined with threaded rubber or having gripping features otherwise. It reduces rolling resistance, saving fuel. It improves drivability. The compliance of the shocks is commensurate with that of a comparable inflated tire, but optimized passively or actively circumferentially, vertically and laterally. Rubber-bushing or spoke-inclination enhances driving stability. Giant field assembled mining-truck-wheels may be produced and deployed and field-assembled quickly by common metalworking shops at fractional cost and weight. It is environmentally friendly, for hardly using or not using rubber. The gas or liquid of the shock spokes may be interconnected and cooled. Soft and hard driving may be controlled manually or by computer on the fly. It is suitable for applications ranging from bicycle wheels to aircraft landing gears. It is fireproof, bulletproof, airless and silent. It cannot bounce or skid at jumpstart or braking and on ice.

### FIELD OF THE INVENTION

This invention relates to airless wheels of rigid rim connected to the hub by a multiplicity of dissipative and compliant spokes, such as shock absorbers. (Shweel is trademark portmanteau for Shock [Absorber] and Wheel).

### BACKGROUND OF THE INVENTION

Numerous efforts were spent on developing airless tires, which never get flat, for that may kill at high speeds. Mining trucks seldom speed, yet their tire often get punctured or damaged otherwise while at work. Their fix is extremely expensive. Rigid wheels (i.e., wheels with rigid rim, hub and spokes, such as cartwheels) do not get flat. However, for lacking the flexibility of an inflated tire, these transfer all shocks of a road bump to the vehicle suspensions, which alone may not ensure smooth ride and may damage the chassis and the road.

To address this problem, Michelin, the great French tire maker, developed the Tweel (portmanteau for Tire and Wheel—not to be confused with the tweel, used in glass making processes—see U.S. Pat. Nos. 3,445,217 and 3,486,876), with polyurethane hub-to-rim radial walls for low speed specialty vehicles, proposing it for lunar explorers. Its price on earth may be prohibitive. The Tweel spoke-walls would bend and deflect upon the wheel hitting a rock.

Note that both Michelin and Bridgestone, as well as many others, hold several patents on wheels with flexible spokes, hubs and rims cast and molded as an integrate part. That core technology is best described in the WO 2008/036787 A2 world patent by Corn in Mar. 27, 2008, assigned to Michelin. Since mud and sand quickly render such Tweel driving useless, the experiments continue, according to Michelin, perhaps one more decade.

Note also that the nested wheel claimed by U.S. Pat. No. 6,701,985 by Russel in Sep. 3, 2004 also addresses rolling radius flexibility with foam sandwiched between two rigid rims, which may work on smooth very pavement until it rains or gets muddy. It transfers driving forces by radial studs in shear and bending, which connect the inner and outer rims. These studs however restrain any movement other than radial, defying purpose.

Upon hitting a small rock, inflated tires deflect locally, absorbing most of the shock and thus provide smooth and quiet ride, until they hit by nail or rifle bullet. Boulders and bumps however, mostly impose upon the vehicle's shock absorbers, which have large viscoelastic displacement capacity. The tire deflection is only a fraction of the vehicle's shock absorbers stroke capacity.

Mass-producible economical wheels with airless no-skid tires, which ensure quiet and smooth rides on any road however are still the dream of the vehicle industry and their customers. Demanded are such wheels thereof.

Also in demand is tire flexibility adjustment on the fly to comply with road and driver demand and may be commanded manually or automatically. To improve on the inflated tire performance, three times more circumferential flexibility, five times more lateral stiffness and two times more radial flexibility is needed. These would improve on braking-and-skidding, handling- and cornering, as well as on the riding comfort respectively.

Additionally and similarly demanded is the addition of greater energy dissipation to wheel elasticity—that is the springiness between the wheel hub and rim—and heat management on the fly thereof.

Moreover, since reduction in wheel rolling resistance saves fuel, wheels with reduced rolling resistance are also in demand.

Finally, the reduction or elimination of the tire disposal in land and sea, keeps the environment clean. Tire may be set on fire. Burning tires emit toxic fumes. Less tires means less such danger.

It may be instructive to mention that in around 1910, great demand manifested in airless tires, which stimulated some to invent wheels with tension-spring spokes, some even with some attenuation. The main reason for that was that the first mass-produced car, the Ford T model, introduced in 1908, used artillery wheels with wooden spokes and rim with inner tube inflatable tires. These 30-inch diameter tubes required 60 psi pressure to remain on the clinched type rim, thus flat tires were frequent and dramatic.

U.S. Pat. No. 570,697 by Chace in Nov. 3, 1896 already claimed spring assistance of bicycle-wheel spokes. However, for obvious reasons now, yet non-obvious then, the prototypes failed, for lacking hinges at the rim and requiring prohibitively larger springs. Dipping in the first mud rendered it useless. Yet, the concept intrigued others.

U.S. Pat. No. 1,114,891 by Kopke in Oct. 27, 1914 attempted to adopt larger springs and added some attenuation by hinged rods friction-sliding in sleeves. However, the hinges and the springs were centrally connected to the hub and thus the test vehicle could not started, though could be kept in jigged motion, once pushed to higher speed.

U.S. Pat. No. 1,155,865 by Aimond in Oct. 5, 1915 attempted to improve on Kopke's design, resolving some circumferential displacement capacity problem, by substituting the rim hinge with cylindrically guided rollers. In a secondary free hub, he guided slider pipes, which incorporated internal and external springs. This solution also lacked moment transfer capacity and also failed in the prototyping phase.

U.S. Pat. No. 1,195,148 by Newman in Aug. 15, 1916 was the last similar attempt using rigid tube rim with shock-like attenuated spokes, however without end hinges and without any spoke eccentricity at the hubs. The moments were supposed to be transferred by the spokes rigid connections. Only one prototype was known to be built. The rigid rim collapsed for having infinitely large Hertz stresses and the spokes broke at the rim connection. For lacking hinges at spoke ends, it did not even provided the needed soft support. It could not be driven from the vehicle, just dragged from outside. Interestingly enough, this inventor draw the attention to the need of sideway stability by inclining and staggering the spokes. Yet, the wheel's rolling radius remained constant at any load. It did not worked differently than a wooden spoke cart wheel.

In the 1920s, the clinch type tube retaining was abandoned and the lower tire pressure appeared to provide the needed softness. The above described early attempts were quickly forgotten, at least until now, when some of these historical solutions reappear in new embodiments. For instance U.S. Pat. No. 6,698,480 almost reads on the aforementioned Chace patent and US 2010/0072807 A1 application on Kopke's patent.

U.S. Pat. No. 8,127,810 B2, US 2009/01152937 A1, U.S. Pat. No. 7,810,533 B2, US 2011/0030861 A1 address braking and acceleration attenuation using circumferential coil springs, while US 2004/0051373 A1, US 2007/0089820 A1, US 2011/0248554 A1 applications and U.S. Pat. No. 7,523,773 B2 patent using leaf springs.

The world's largest, 13.22-ft diameter, 11,680-lbs heavy Caterpillar 797F wheel, with $42,000 (2010 USD) price tag and two-years preordering time, was not even dreamed by then. The problem today manifests in a different way and begs for solution with modern materials, techniques and technology. Finding economical solution thereof is the object of this invention.

### SUMMARY OF THE INVENTION

The above problems and others are at least partially solved and the above objects and others realized in a process, which according to the teachings of this invention, uses wheel comprising a rigid rim and a rigid hub, interconnected by a multiplicity of compliant and dissipative spokes, hinged at the ends with sufficient eccentricity to transfer driving and braking forces and moments between the hub and the rim. Engineered, short-stroke, high-load-capacity shock-absorbers or air-shocks (pre-compressed air-springs) are proposed to serve as wheel spokes, preferably arranged and hinged to ensure lateral load transfers. This novel wheel is referenced here as Shweel and Shock Spoke Wheel (SPW) elsewhere.

Short stroke is sufficient to absorb the impact of hitting small rocks. Larger shocks remain to be absorbed by the vehicle's shock absorbers, which need not be necessarily different than the ones used on vehicles with inflated tires. That results in a very quiet and comfortable ride, and even reduction in rolling resistance.

The outer side of the rigid rim may be covered with a layer of rubber with threads similar to a comparable inflated tire's outer side. Heavy machinery may have deformed, cast or weld-on protrusions, similar to such features common on tracks, used on military tanks and construction cranes. Large Shweels, used on mining trucks, would be extremely economical. Their shortage could be eliminated in short order, because such a Shweel can be built without special knowledge using widely available and inexpensive off-shelf materials and components.

### BRIEF DESCRIPTION OF THE DRAWINGS

Referring to the drawings:

FIG. 1A is a diagrammatic elevation view of a Shweel according the teachings of this invention.

FIG. 1B illustrates the cross section of the same Shweel.

FIG. 2A is an elevation view of another Shweel.

FIGS. 2B, 2C and 2D are alternative cross sections of the Shweel shown in FIG. 2A.

FIG. 3A is a perspective view, with a partial cut-off, illustrating an air-shock modified to better suit Shweels.

FIG. 3B is a perspective view of the air-shock shown in FIG. 3A, but here with added air-cooling ribs.

FIG. 3C is a diagrammatic sketch illustrating the operation of an active shock-spoke with forced cooling.

FIG. 4A is a perspective view of a mounting bracket for the air-shocks illustrated in FIG. 3A and FIG. 3B.

FIG. 4B is a side view of a mounting bracket, using convex pillow block for mounting to the rim of a Shweel.

FIG. 4C is a side view of a mounting bracket, using concave pillow block for mounting to the hub of a Shweel.

FIG. 5 is a perspective view, with a partial cut-off, illustrating an exemplary Shweel, suitable for cars and trucks, using hollow sheet metal rim and threaded rubber liner rim construction.

FIG. 6A is illustrating a perspective view of the liner shown in FIG. 5.

FIG. 6B is illustrating a perspective view of the hollow rim shown in FIG. 5.

FIG. 6C is illustrating a perspective view of an alternative hollow sheet metal rim, with deformed threads, which may substitute the rim components illustrated in FIG. 5.

FIG. 7A is a perspective view of the shock-spoke assembly illustrated in FIG. 5.

FIG. 7B is another perspective view of the shock-spoke assembly illustrated in FIG. 5, but with added air-cooling ribs on the shocks.

FIG. 8 is a perspective view, illustrating another exemplary Shweel, with inner and outer shock-spokes, suitable for trucks and off-road vehicles, which best utilize no-rubber airless tires.

FIG. 9 is illustrates the same as FIG. 8, with partial cut off, whereas the Shweel is covered inside and outside with sheet metal dust-mud-and-dirt cover, suitable for mining operation and for the military.

FIG. 10A is an isometric view of a hollow metal rim segment.

FIG. 10B is an isometric view of deformed sheet metal outer Shweel cover segment.

FIG. 11 is a perspective view, with a partial cut-off, illustrating another exemplary Shweel, suitable for agricultural, construction and mining vehicles and machineries, using solid ribbed rim.

FIG. 12 is a perspective view, illustrating yet another exemplary Shweel, suitable for general purpose industrial vehicles and machineries, using solid rim and light duty shock-spoke attachments.

FIG. 13 is a perspective view of a segment of a solid rim, suitable to build Shweel rims shown in FIG. 11.

FIG. 14 is the same preassembled for shipping with shock-spokes, shown in FIG. 3A.

### DETAILED DESCRIPTION OF A PREFERRED EMBODIMENT

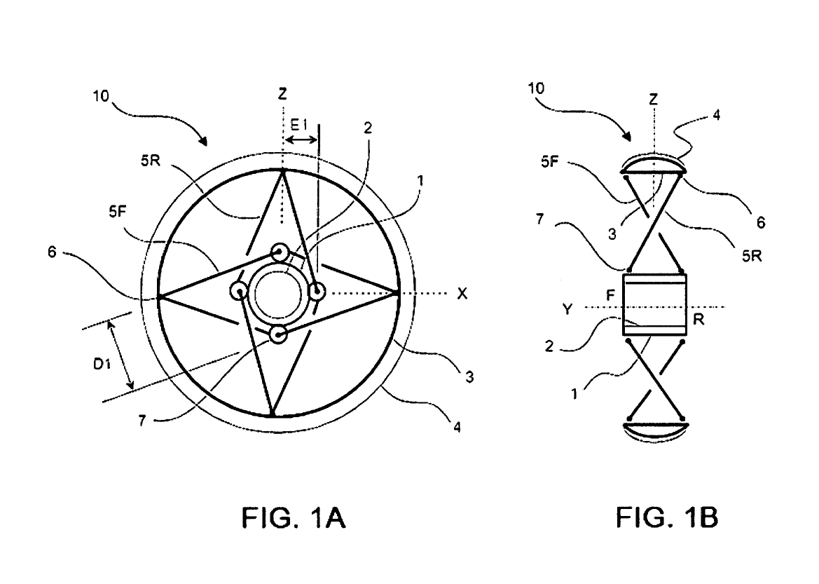

Attention is now turned to FIG. 1A, which illustrates a preferred embodiment of this invention by a diagram, showing a side-view (elevation) of a Shweel, assembly 10, which is a vehicular wheel using diagonal shock-absorber-spokes holding a rigid rim and hub together, with compliance and energy dissipation.

Assembly 10 is a Shweel, comprising a hub 1, running on bearing 2, a semi-toroidal rigid sheet-metal rim 3, with threaded rubber liner 4, four front leaning shock absorber spokes 5F, four rear leaning shock absorber spokes 5R, all eight attached to said rim by hinges 6, and to said hub by hinges 7.

Shweel 10 rolls in horizontal direction X. Half of the axel load acts on the hub center along vertical axis Y by eccentricity E1 to the right, while the other half, with the same eccentricity to the left. Said shock-absorber-spokes transfer hub-to-rim driving/braking moments via driving/braking force-eccentricity D1.

Attention is now turned to FIG. 1B, which diagrammatically illustrates the cross section of Shweel 10 shown in FIG. 1A.

Components 1 through 7 are labeled the same way as in FIG. 1A thereof. Additionally, the horizontal hub axis Y is shown and the face of the hub is labeled F, while its rear R. Rim 3 is shown as a hollow sheet metal semi-toroidal structure. For simplicity the details of liner 4 to rim 3 and its treads are not shown in this diagram.

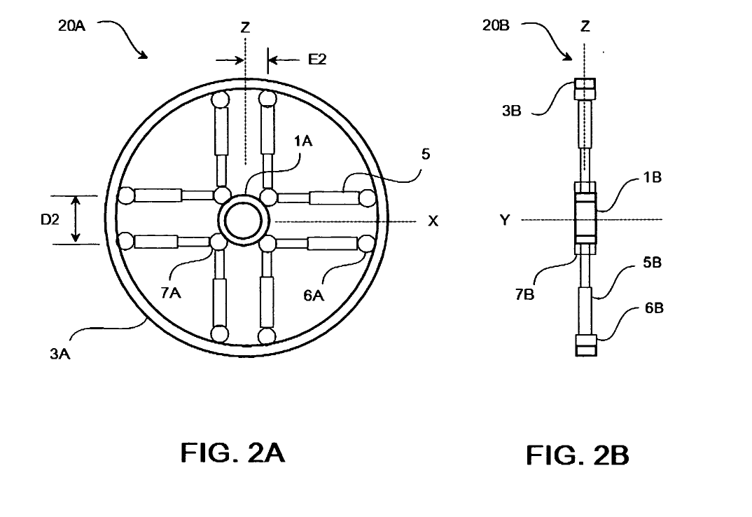

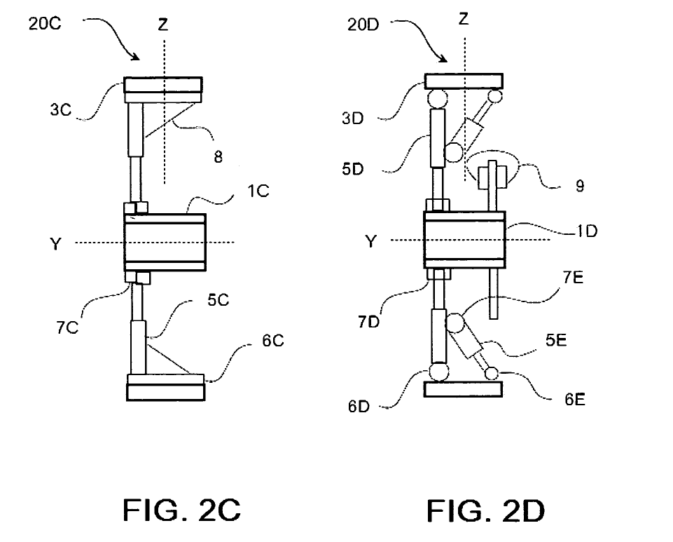

One may notice that each second spoke leans forwards, while each second one—staggered—rearwards in the Y-Z plane. That ensures across wheel stability at driving and vehicle turning. It also ensures an angular compliance of the vehicular Y-Z plane to X-Y plane. Note however that the cross section of rim 3 may be rectangular or in any suitable shape and may be open or closed, as wheel use demands. Also that liner 4 may be omitted and substituted thereof by gripping features of the sheet metal rim itself. Finally that thin wheels, such as motorcycle and bicycle wheels, may use planar shock spokes with appropriately hinged ends, which may ensure across stability however as that is shown in FIG. 2B.

Attention is now turned to FIG. 2A, which diagrammatically illustrates another preferred embodiment of this invention, showing a side-view (elevation) of another vehicular Shweel 20A, with compliant and dissipative planar spokes.

Shweel 20A comprises a hub 1A, a rigid hollow metal-rim 3A, with threaded rubber liner (not detailed here), eight shock absorber spokes 5, all attached to said rim by hinges 6A, and to said hub by hinges 7A.

Shweel 10 also rolls—forward or backward—in horizontal direction X. Half of the axel load acts on the hub center along vertical axis Y by eccentricity E2 to the right, while the other half, with the same eccentricity to the left. Said shock absorber spokes (shown as common or modified automotive gas-shocks) transfer hub-to-rim driving/braking moments via driving/braking force-eccentricity D2.

Attention is now turned to FIG. 2B, which diagrammatically illustrates the cross section of Shweel 20B, as one alternative, shown in FIG. 2A. Such alternative is for narrow wheels, used in bicycles, motorcycles, carts, industrial equipments and such. Also is for belt driven flywheels, for which the springiness of the compliant spokes provide belt tightening.

Components are labeled in correspondence to that of shown in FIG. 2A, however, with letter B, indicating alternative B. Assembly 20B thus comprises hub 1B, rim 3B, shock spokes 5B hinged to hub 1B by hinges 7B and to rim by hinges 6B.

Notice that hinges, labeled 7B, join two shocks. To accommodate that, one of these two hinges is split like a fork. That accommodates the other shock. Note that the adjacent hinges, labeled 6A in FIG. 2A, may be joined, as shown in FIG. 1A (hinges 6), using split hinges, similar to the ones marked 7B. Note also that such hinges may be constructed with pipe rings. With rubber bushings (common on automotive gas-shocks), a limited out of plane compliance is added to Shweel 20B. Such bushings however may be rigid (such as cylindrical or spherical bronze sleeves). Shweels with rigid joints and planar shock-spokes are non-compliant in direction Y. These rely on the vehicle's suspension system for lateral compliance.

Note that the two perpendicular shock-spokes need not necessarily be joined on a common axis to the hub. One simple rubber-isolated eye-ring at each shock-spoke ends may simply be joined to a yoke, having two pairs of eye holes separated with clearance to accommodate each shock-spokes individually instead (see FIG. 4A). Note also that, alternatively, the shock-spokes may end in yokes and the hub may accommodate mounted bearings similar to the one which is used to support machinery shafts in rotation.

One may notice that assembly 20B works even with wide hub and rim (e.g., as wide as shown in FIG. 2C), even if the plane of the shock-spokes is offset to the wheel center. Such configuration may be suitable for car wheels, which requires some space for disc-brake or drum-brake or driving motor (see that in the well published Michelin Action Wheel). Such wheels are shown in FIGS. 2C and 2D next.

FIG. 2C diagrammatically illustrates the cross section of Shweel 20C, as another alternative, shown in FIG. 2A. Such alternative is for cars and trucks and such vehicles.

Components are labeled in correspondence to that of shown in FIG. 2A, however, with letter C, indicating alternative C. Shweel 20C thus comprises hub 1C, rim 3C, shock spokes 5C, which are hinged to hub 1C by hinges 7C and to rim by hinges 6C.

Notice that hinge 6C are extended across the wheel width and connected to shock-spokes 5C via gusset plates 8. Hinges 6C are long enough to accommodate compliance in direction Y. Such compliance may however be provided by small shocks as illustrated in FIG. 2D next.

FIG. 2D diagrammatically illustrates the cross section of Shweel 20D, as yet another alternative, shown in FIG. 2A. Such alternative is also for cars and trucks and such vehicles.

Components are labeled in correspondence to that of shown in FIG. 2A, however, with letter D, indicating alternative D. Assembly 20C thus comprises hub 1D, rim 3D, shock spokes 5D, hinged to hub 1D by hinges 7D and to rim by hinges 6D.

Notice that the gussets 8 (shown in FIG. 2C) here are substituted by auxiliary shocks 5E, with hinges 7E and 6E. Also, that brake assembly 9 indicates the space needed for brakes, motors and other components, common in car wheels.

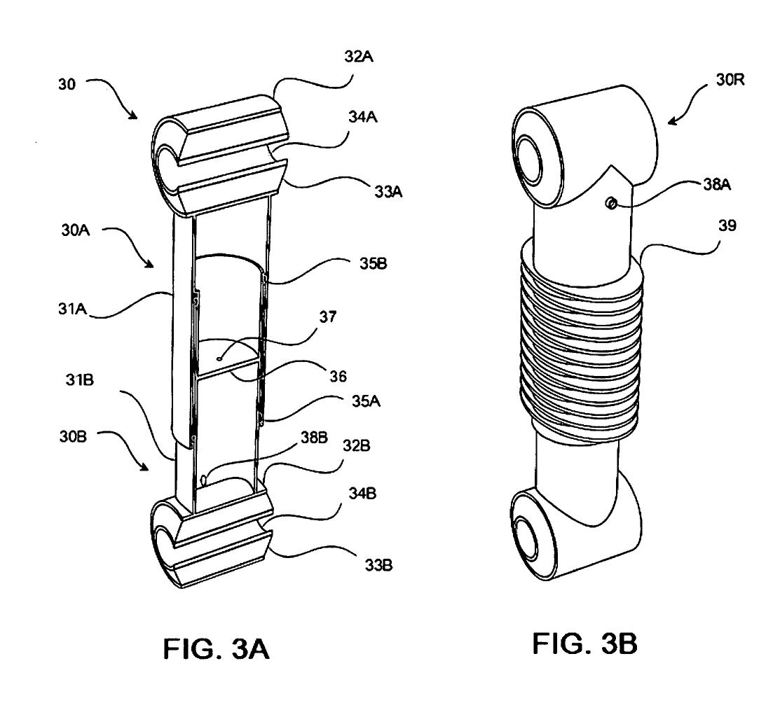

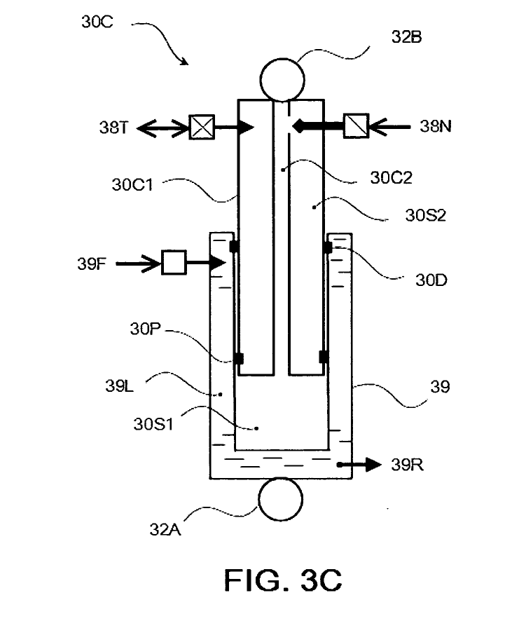

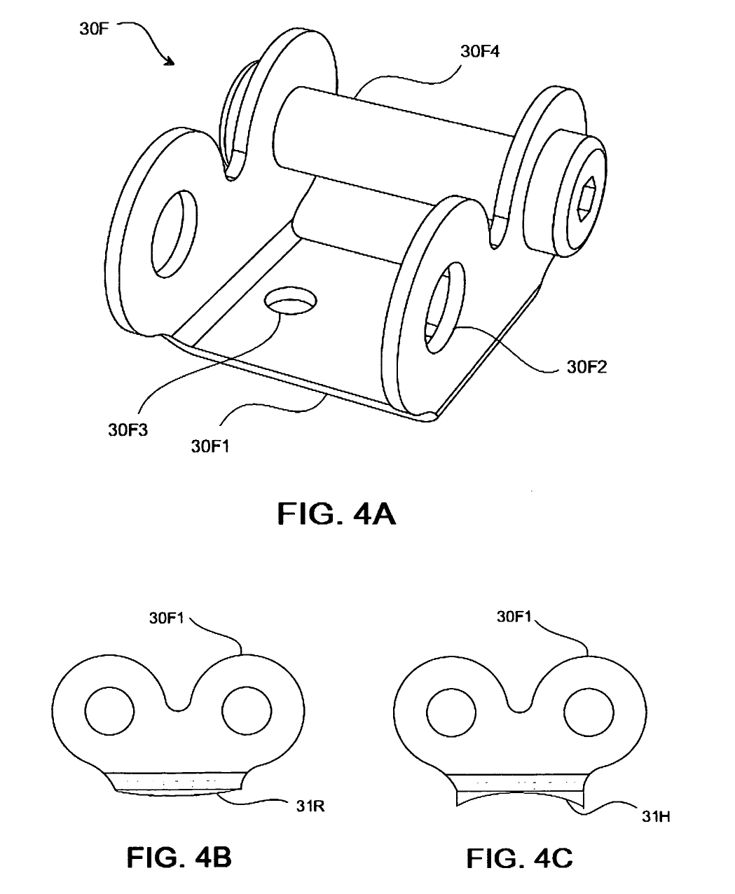

One may acknowledge that, once the Shweel is rolling art high speed, the shock-spokes of the Shweels are well cooled by the passing air. Such air cooling however may be assisted by ribs on the shocks (see FIG. 3B). One may also acknowledge that the eight shock-spokes at four times 90°, as shown in FIG. 2A, may be substituted by six shock-spokes at 120° or by ten shock-spokes at 72°, and so on. Also, that the shock-spokes may be dissipative and may have internal orifices, valves or check-valves to ensure higher stiffness in compression than in tension and may be filled with other gas than air (for instance with argon or xenon gas). Also, that coil-spring assistance may add shock-spoke elasticity and hydraulic dashpot viscosity. Also, that off-shelf rod ends, such as universal-joints, ball-joints, elastomeric-isolated-eye-ring and such, are well suited to connect the shock-spoke to the rim or the hub, though one may rather optimize or modify such joints to better serve this specialized application. Finally, that shock-spoke may have internal or external displacement limiters, both in compression and tension, either compliant or rigid.

Note that elastomeric isolated-eye joints are common on automotive shock absorbers. These are free to rotate around one axis and resist moment and restore angular displacement around a perpendicular axis. Therefore, these are well suited for in-plane shock-spokes.

Attention is now turned to FIG. 3A, which is a perspective view, with a partial cut-off, illustrating an air-shock, assembly 30, a shock-spoke, modified to better suit Shweels. Shock-spoke 30 is shown at its mid-stroke setting. When filled with argon or xenon or other suitable gas (instead with air), this air-shock becomes a gas-shock.

Shock-spoke 30 comprises a larger half-spoke 30A and smaller half-spoke 30B subassemblies. Half-spoke 30A best connected to a Shweel's rim, while 30B to the Shweel hub. However, a reverse connection is just as functional. If accordion type dirt cover sleeve is not used, which however are common on vehicular shock absorbers, the proposed connection more effectively keeps the dust, dirt and mud away from the shock seals.

Shock-spoke-half 30A comprises a pipe sleeve 31A, welded to mounting sleeve 32A, which is bonded to elastomeric bushing 33A, which in turn is bonded to bushing sleeve 34A. Similarly, shock-spoke-half 30B comprises a pipe sleeve 31B, welded to mounting sleeve 32B, which is bonded to elastomeric bushing 33B, which in turn is bonded to bushing sleeve 34B; and additionally, a diaphragm 36, welded at around the midstroke ok of shock 30, having a small orifice 37. Assemblies 30A and 30B are separated by seal-ring 35A, which is recessed in pipe 31A, and seal-ring 35B, which is recessed in pipe 31B. The other side of orifice 38B, a valve assembly is welded on, similar to inflated tire valves. For easy access, such valves, serving the gas or air pressurization of shock 30, may be repeated in both sides of pipe 31B or in one or two sides of pipe 31A. Such repetition however is not a must.

Limited by the size and cone angle of bushings 33A and 33B, shock 30 is able to accommodate lateral loads and restore corresponding angular, radial and axial displacement between sleeves 32A and 34A, as well as between sleeves and 32B and 34B. That ensures the Shweel's out-of-plane compliance and strength. However, mounting compliance is not a must for all Shweels, so Shock 30 may be constructed with rigid—say hard plastic or metallic—bushings 33A and 33B, or even without any bushings, but sleeves.

Shock 30 is pressurized, and thus, provided that orifice 37 is small, ensures nonlinear (progressive) static and dynamic load transfers between bushings 34A and 34B, both in tension (stretch) and compression (shrink), alas with different stiffness and viscosity (nonlinear shock-and-vibration-attenuation). However, diaphragm 36 with orifice 37 may be eliminated, since shock-spoke attenuation is not a must.

The free side of pipe 31B may be covered with state-of-art elastomeric accordion for dust protection, which restricts lubricant evaporation as well. Oil or grease may lubricate sealant rings 35A and 35B. Some oil may be left splashing inside shock 30, on both sides of diaphragm 36. Seals 35A and 35B may be constructed using a multiplicity of rings, which may include open or split metal rings similar to the ones used to seal engine pistons in cylinders, oil pull-down rings, Teflon rings and structural rings, for these are not only in sliding but in lateral load transfer as well.

Similarly, diaphragm 36 may be a multiplicity of diaphragms to boost shock attenuation and heat transfer rate, and cooling thereof. Diaphragm 36 may be located on lower or higher elevation however, retaining more or less gas participating in shock attenuation correspondingly, ensuring less or more dynamic stiffness. Diaphragm 36 may be configured as a plug, containing a check valve, to further alter shock impedance asymmetry, measurable in spoke tension and compression. Such asymmetry, help preventing wheel slip at sudden acceleration or braking and enhances vehicular handling and cornering. Adding pre-compressed coil springs around the shock 30, would decrease the operating air pressure of the shock. That has specific advantages and disadvantages to consider in design. Adding computer controlled pressure variation and setting adjustment allows easy switching between comfortable drivability on hard, rough, soft and muddy road and on sands or on rip-rap. Through the hub air pumping may render that similarly as tires are inflated on the ride today.

The stroke of shock 30 shall be commensurate with the tire deflection of a comparable size wheel with customary inflated tires. A Shweel is not expected to eliminate the vehicular shock absorbers, though it may reduce their size, number, arrangement and cost. Too soft and too few shock-spoke in a wheel may result in excessive shock-poke heating. Shock-spokes however may be cooled by ribs on pipe 31A—as that is shown in FIG. 3B—or by forced liquid cooling, pumped through the hub.

FIG. 3B illustrates a preferred air-cooling of shock-spoke 30R by a perspective view of the air-shock shown in FIG. 3A, but with added air-cooling ribs 39. It also shows inflating valve 38A.

FIG. 3C diagrammatically illustrates a preferred liquid cooling method of a preferred shock-spoke 30C with added active pressure control.

Shock-spoke 30C is hinged at its ends with hinges 32A and 32B, the same way as shock-spoke 30 and 30R are. Its piston 30C1, holding seal 30P, moves in its cylinder 39, which holds seal 30D, acting as a dashpot. Gas volume 30S1 receives the shock, which is attenuated in the coupled accumulator volume 30S2, interconnected with pipe volume 30C2, which acts as a Venturi constriction. The Venturi and attenuation effect is passed, blocked or altered (controlled) by the opening, closing or adjusting the orifice size by a needle valve, which is actuated by controls 38N, coming from the vehicle's onboard computer. Suitable piezoelectric or piloted hydraulic or pneumatic needle valves are off shelf items today.

The base pressure, which sets the shock-spoke 30C pre-compression, is controlled by a common feed-and-return high-pressure pneumatic line 38T, which is also controlled by the vehicle's computer (not shown). This sets the pressure to accommodate riding on sand, mud, dirt, hard-pavement, soft-pavement, rip-rap, rocks, obstacle course, and other road conditions. On the ride, that setting may be decided by the computer or by the driver.

Shock-spoke 30C is cooled by liquid 39L (say water, engine coolant or oil) encased in vessel 39, fed through controlled feed-line 39F and discharged by return line 39R. Obviously, piston 30C1, rather than the cylinder 39, may be cooled instead—or both can be cooled.

Said controls and fluids and gases are to be passed through the Shweel hub, using state-of-art means, similar to pumping air into shot-through or poked-through inflatable tires, found mostly in military vehicles.

It shall be obvious that hinge 32A may be connected to the Shweel hub and hinge 32B to the Shweel rim, while pressure control 38T may connect to volume 30S1 (instead of volume 30S2). In this case, attenuation control 38N may be omitted and the pipe of piston 30C1 replaced with diaphragm 36 with orifice 37. That would greatly reduce the moving mass of shock-spoke 30C, thereby reducing undulating stresses of the Shweels rim, which are associated with centripetal forces on piston 30C1. Should one wish to retain control 38N, in this case, that needs be embedded wireless, powered by piezo-electricity generated inside piston 30C1, harvesting the pressure oscillation of shock-spoke 30C. This and other similar configurations, serving the same purpose, are within the teachings of this invention.

Attention is now turned to FIG. 4A, which illustrates in perspective view of a mounting bracket, assembly 30F, proposed for mounting the air-shocks, shown in FIG. 3A or FIG. 3B to the Shweel's hub or rim.

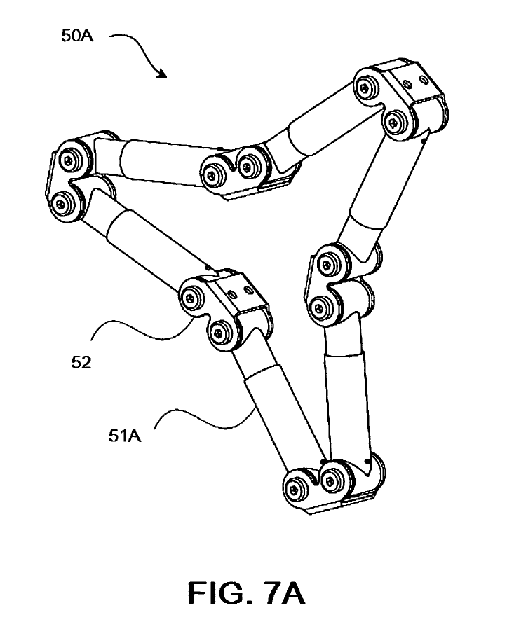

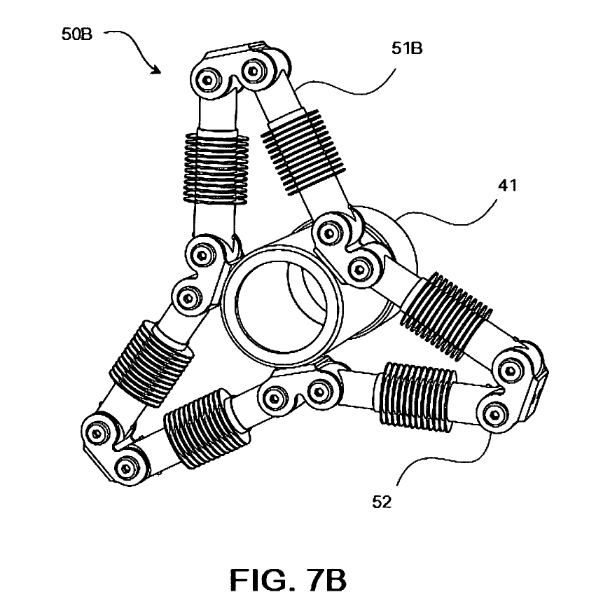

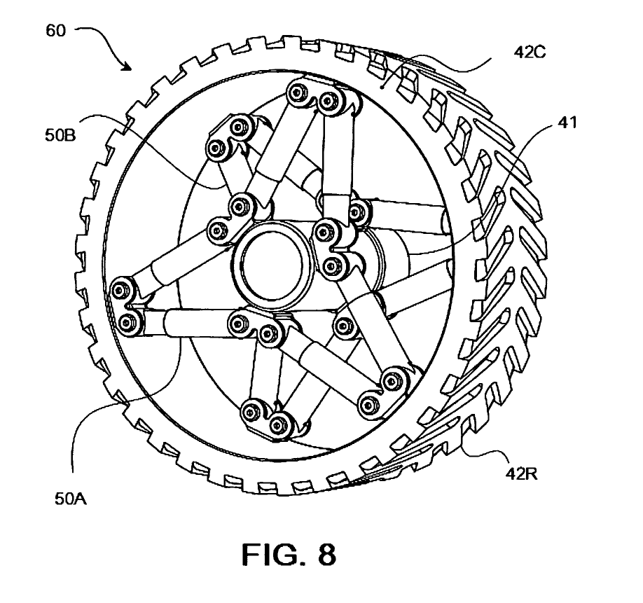

Bracket 30F comprises clevis 30F1, with four mounting holes 30F2 to mount two shock-spokes, two fixture holes 30F3 to fix clevis 30F1 to either the hub or the rim of a Shweel, and a double headed dowel 30F4, which however needed in pairs, when two shock-spoke need to be connected to bracket 30F. In a bracket shock-spoke assembly (see FIGS. 7A and 7B) a bracket 30F with one dowel 30F4, is considered to belong to any shock-spoke.

Since clevis 31F has a flat base, hard plastic or metal pillow blocks may accommodate its mounting to the hub and the rim of a Shweel. That is, block 31R (shown in FIG. 4B) may be used at rim connection and block 31H (shown in FIG. 4C), at hub connection thereof. Alternatively, connector plates, forks, clevises or brackets, bent or cast may be used with similar convex or concave mating surfaces respectively.

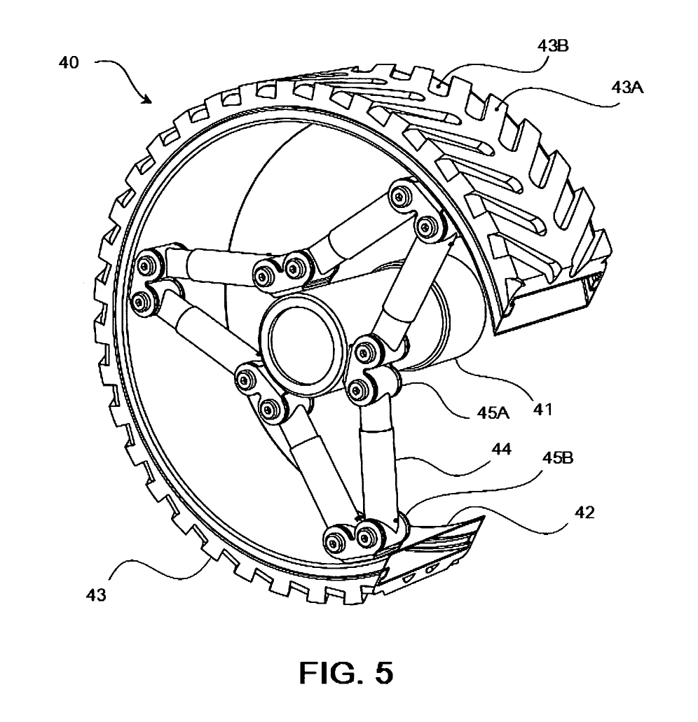

Attention is now turned to FIG. 5, which illustrates a preferred embodiment in perspective view, with a partial cut-off, exemplary Shweel 40, suitable for cars and trucks, using hollow sheet metal rim and threaded rubber liner rim construction.

Shweel 40 comprises a hub 41, a hollow metal rim 42, a rubber tire shell 43, with extruded thread ridges 43A and valleys 43B, six air-shock-spokes 44, three inner brackets 45A, and three outer brackets 45B.

Notice that the shock-spokes are located near to the outer perimeter of the rim to clear the inner space between hub and rim for disk or drum brake assembly (not shown). However, when no such space requirement is imposed, the shock-spokes may be located at the center of the rim. Such a Shweel, with narrow rim, may well serve motorcycles and even bicycles (not illustrated).

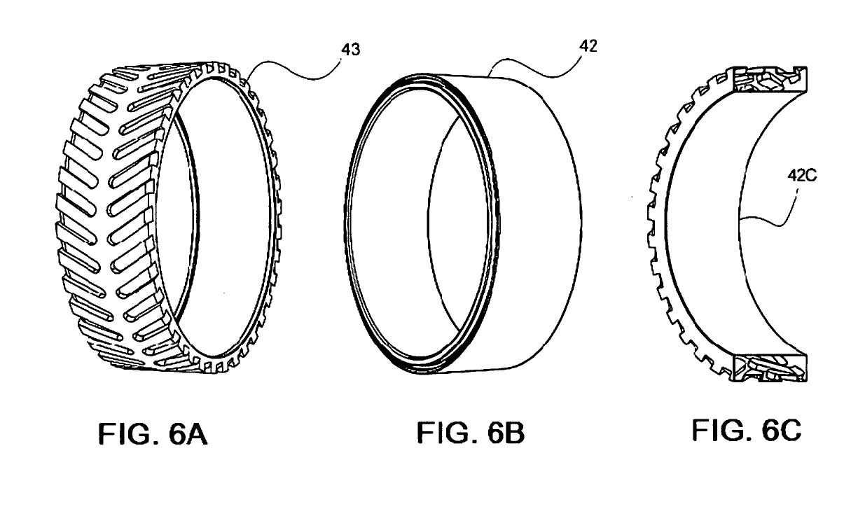

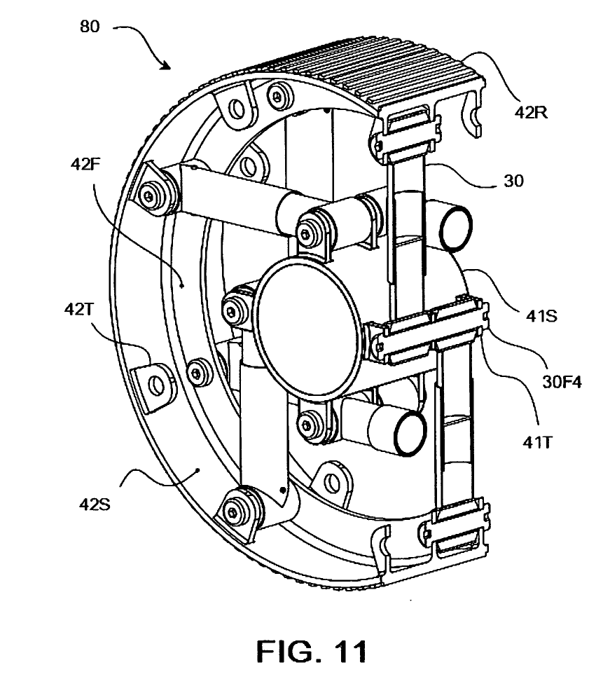

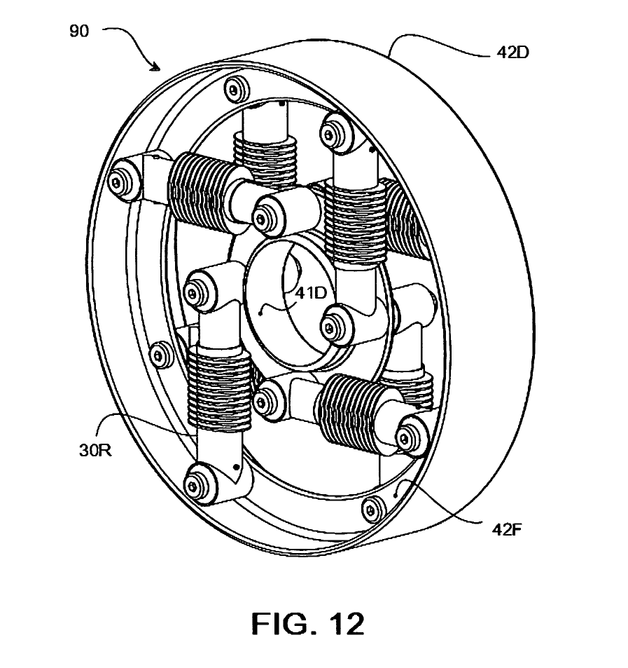

One may see that a Shweel rim can be constructed in several ways. For instance, composed with tire shell 43, as that shown in FIG. 6A mounted on rim 43, as shown in FIG. 6B, or as a sheet metal rim 42C, as shown in FIG. 6C, which has tread-like deformations. Rim 42 and 42C however need not be hollow, but solid. Solid metal rims may well suit mining, construction, agricultural and military vehicles (see FIGS. 11 and 12). While it is not shown, one may recognize that state-of-art metal rim, with inflatable tire, in which the air is replaced with elastomeric or rigid foam, may also serve as airless tire for Shweel applications.

Also, that the shock-spoke of a Shweel may be preassembled, coupled with brackets, for instance, as that is shown in FIG. 7A by assembly 50A, comprising six shock-spokes 51A and six brackets 52. FIG. 7B illustrates the same, with assembly 50B, with six shock-spokes 51B having cooling flanges, six brackets 52 and a hub 41.

Attention is now turned to FIG. 8, which is a perspective view, illustrating another exemplary embodiment of this invention, Shweel 60, having on its hub 41, six outer shock spokes 50A and six inner shock-spokes 50B, suitable for trucks and off-road vehicles, which best utilize no-rubber airless tires, but an internally stiffened hollow sheet metal rim 42C, with deformed road gripping ribs 42R.

One may perceive that such Shweel can be very useful in the Arctic and—in general—in snow. Sized properly, it may float amphibians as well. The military may appreciate that. Also that a metal Shweel may be fired-at with bullets, yet, it would keep moving harmlessly. Having no rubber, it cannot be set on toxic fume fire. Once it discarded, it rusts away much sooner than rubber tires do. It is non-hazardous and environment friendly. Shweel making and use are green technology thereof.

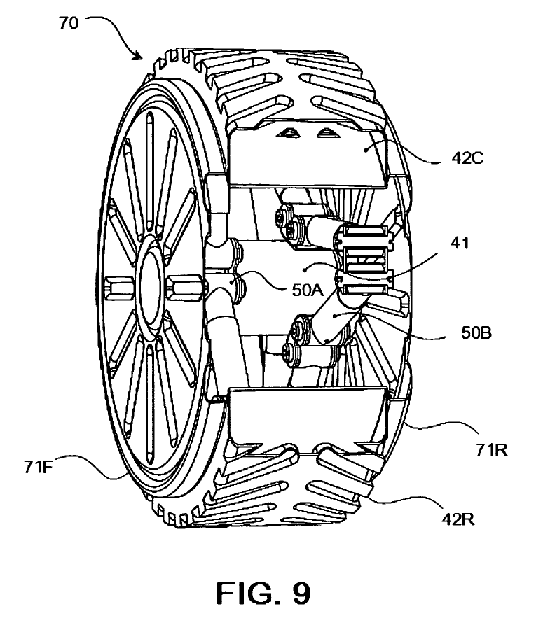

Attention is now turned to FIG. 9, which illustrates Shweel 70, with partial cut off, however covered outside (front) and inside (rear) with sheet metal dust-mud-and-dirt covers 71F and 71R respectively, while otherwise labeled as that of FIG. 8. This preferred embodiment is suitable for mining operation and for the military. Since hub 41 passes through rear cover 71R, the inner edge of cover 71R must clear hub 41. The clearance however may be covered with rubber accordion or with overlapping plates (not shown).

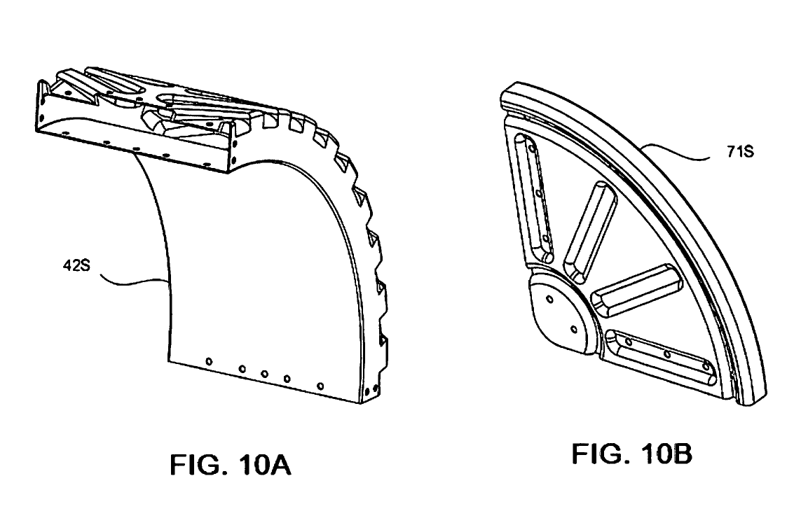

Shweel 70, if it is as large as the world largest inflatable tire (13.22 ft in diameter), may be constructed in segments and assembled in the field (mine or construction site). FIG. 10A illustrates a quarter segment (felly) of rim 42S (as a segment of rim 42C), while FIG. 10B illustrates a corresponding segment cover 71S, a segment of cover 71F. Cover 71R may be segmented similarly (not shown). While the manufacturing, handling, shipping and mounting of such a large inflated tire requires considerable capital investment, special skills and equipments and long time to produce, deliver and install; field assembled Shweels of the same size and strength may be manufactured by almost any sheet metal and machine shop at fractional cost, and may be quickly produced, deployed and installed at fractional time and effort.

Note that rear truck wheels are often doubled at each end of the axle. For instance, a Caterpillar 797F truck has four 13.22-ft diameter tires on the rear two axises and two on the front axes. It shall be obvious that replacing these with Shweels, illustrated in FIG. 9 is straightforward. However, such Shweels may not need to be as wide. Single layer shock-spoke narrow Shweels may serve equally well, or even better, in tandem. Such tire replacement (twelve, instead of six, in this case) could be beneficial, since each layer of Shweel can then deflect independently, distributing the load more evenly on rough terrain.

Attention is now turned to FIG. 11, which is a perspective view, with a partial cut-off, illustrating another exemplary Shweel 80, which may be suitable for agricultural, construction and mining vehicles and machineries, using solid ribbed steel or cast iron rim 42S with ribs 42R and with flange 42F reinforcement. Its eight shock-spokes 30 are hinged to solid hub 41S, having attachment tabs 41T, in which pin 30F4 anchors shocks 30 to hub 41S. Tabs 42T on rim 42S may be omitted or used to attach Shweel covers. Solid rims may also be constructed from segments (not shown). In smaller size Shweel, rim 42S may be non-metallic, say fiber reinforced engineered plastic, which is light, strong and thus may serve Shweels comparable in size to recreational vehicle wheels.

Attention is now turned to FIG. 12, which is a perspective view, with a partial cut-off, illustration of yet another exemplary smooth Shweel 90, suitable for general purpose industrial vehicles and machineries, having solid rim and light duty shock-spoke attachments, using eight air-cooled shock-spokes 30R, hinged to flanged hub 41D and to solid rim 42D, stiffened with flange 42F.

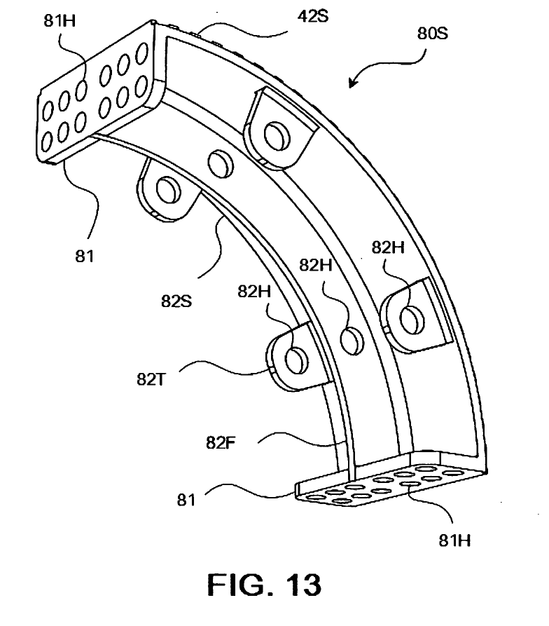

FIG. 13 is a perspective view of a solid rim quadrant segment 80S, four of which may a build Shweel rim, similar to the one, which is shown in FIG. 11. For a 13.22-ft diameter rim, one quadrant segment is only 9.32-ft long. Thus, while rim 42S of that size does not fit in a highway container, a quadrant segment of it does. That alone, cuts current transportation cost of such a large wheel to a fraction. Currently, the shipping cost of such a large wheel often exceeds its purchase price.

Segment 80S, which may be a solid cast iron part, has the following necessary features, most of which are identical to such features shown in FIG. 11: two coupler flanges 81, each with twelve coupling holes 81H, rim 82S with a multiplicity of ribs 42S outside and stiffened with rib 82F inside, having two mounting holes 82H, and four mounting tabs 82T, each with one mounting hole 82H. Mounting bolts (not shown) join four segments 80S to form a Shweel rim, similar to the one is illustrated in FIG. 11. Ribs 42S may be hardened or built up from hard material.

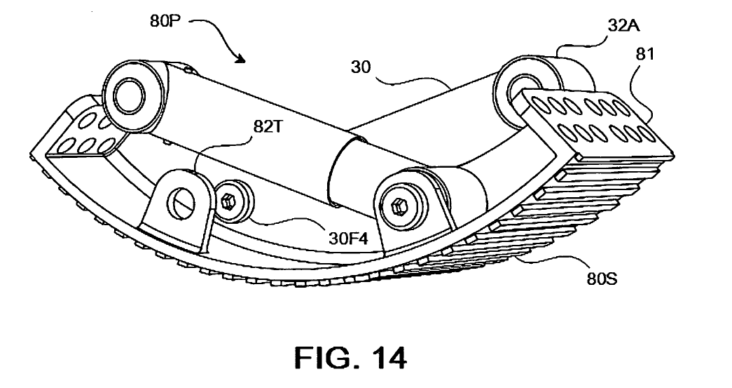

The advantage of the segmental large Shweel shall be obvious by now. Segments 80S may be transported preassembled with their tributary shocks in regular highway containers. FIG. 14 illustrates, at last, one such preferable subassembly, comprising a segment 80S, two shocks 30, each mounted with dowel 30F4 at one end. Once transported as shown, perhaps wedged in a flatbed truck, the two empty tabs 82T may be used to tie down shocks 30, so that each sleeve 32A touches one flange 81, and to lift this pre-assembly 80P, as well as to tie down to the flatbed. Simple forklift, instead of the current specialized equipment, may be used for quick field assembly. Any shock-spoke 30 is replaceable individually, should the need arise due to damage or wear. Replacement parts, rather than whole wheels may be stored handy at the field. That reduces the maintenance cost of giant vehicles, which ride on large wheels. Note however, that preassembly is not a must and that the field assembled shocks may be pressurized on the field.

The present invention is described above with reference to a preferred embodiment. However, those skilled in the art will recognize that changes and modifications may be made in the described embodiment without departing from the nature and scope of the present invention. For instance, application of the Shweel may not be limited to on-road and off-road vehicular wheels. Even railroad wheels may be built with shock-spokes for braking skid control and vibration and noise reduction, especially on bullet trains. Supplementing said gas-shocks, used as wheel-spokes, with actively controlled hydraulics, using pumps, pipes, reservoirs, valves, check-valves, radiators and fans (that is, components, beyond the ones shown here) is considered obvious and instructive over the teachings of this invention. Combination of Tweel with Shweel and collapsible Shweel configuration are also considered instructive.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Shock attenuating wheel, called Shweel, comprising a sufficiently rigid rim and a hub interconnected by a multiplicity of gas-shock spokes, having, progressively-hardening stiffness with nonlinear-elastic-displacement-restoring capacity arranged to ensure driving-force, braking-force, static-load, undulating-load, shock-load, and sideway-load transfers between said hub and rim, all along its rolling and turning motions, while the ends of said spokes are hinged to said rim and hub by means allowing for said load transfers, with equal capacities in forward and reverse wheel turning directions, without significant restriction of the displacements associated with said loads, and whereas said spokes are pre-compressed.

2. Wheel as per claim 1, whereas said rim is covered with road-gripping and liquid-diverting exterior rubbery layer.

3. Wheel as per claim 1, whereas said spokes are spring assisted shock absorbers.

4. Wheel as per claim 1, whereas at least one of said spokes comprises hydraulics.

5. Wheel as per claim 1, whereas said spokes has means to enhance its air-cooling.

6. Wheel as per claim 1, whereas said spokes has means to enhance its cooling by liquid pumped through a heat-exchanger.

7. Wheel as per claim 1, whereas said spokes have means for pressure control, including setting and adjustment.

8. Wheel as per claim 1, whereas said spokes are mounted in hardware with pillow blocks.

9. Wheel as per claim 1, whereas said spokes are mounted with compliant bushings.

10. Wheel as per claim 1, whereas said spokes are mounted with rigid joints allowing for unobstructed rotation at least in one direction.

11. Wheel as per claim 1, whereas said rim has features improving road gripping and liquid displacement.

12. Wheel as per claim 1, whereas said rim is covered at least on one side with attached cover structure, which sufficiently clears said hub.

13. Wheel as per claim 1, whereas said rim is covered at least on one side with attached cover structure, whereas at least one side of said cover is built up.

14. Wheel as per claim 1, whereas said rim comprises inflatable tire filled with consolidated foam.

15. Wheel as per claim 1, whereas the compressed gas in at least two of said spokes are interconnected to form a common volume.

16. Wheel as per claim 1, whereas the compressed gas in said spokes are isolated from each other.

17. Wheel as per claim 1, whereas the compressed gas in at least two of said spokes are interconnected to form a common volume and commonly controlled by an active control system.

18. Wheel as per claim 1, whereas the compressed gas in at least two of said spokes are isolated from each other and controlled independently.

19. Wheel as per claim 1, whereas said rim is built up field assembled.

20. Wheel as per claim 1, whereas said rim is built up from joined segments on the field-of-use to where such segments are received at least partially pre-assembled at least with one more part.
